(19) United States
(12) Patent Application Publication
(10) Pub. No.: US 2023/0320472 A1
(43) Pub. Date: Oct. 12, 2023

(54) NAIL FILING, BUFFING AND COLOR CHANGING SYSTEM

(71) Applicant: KQ2 Enterprises, LLC, Logan Township, NJ (US)

(72) Inventor: Kellie Terry, Logan Township, NJ (US)

(21) Appl. No.: 18/131,732

(22) Filed: Apr. 6, 2023

Related U.S. Application Data
(60) Provisional application No. 63/328,318, filed on Apr. 7, 2022.

(51) Int. Cl. A45D 29/05; A45D 29/00

(52) U.S. Cl. CPC A45D 29/05; A45D 29/004

(57) ABSTRACT

A method for changing nail color comprises selecting, via a software application on a computing device, a color from a color palette comprising a plurality of color options, and transmitting from the computing device an electronic signal to an electronic device, wherein the electronic signal identifies the selected color. The electronic device generates a functional stimulus to change a color of a nail of a user to the selected color. The functional stimulus is applied to the nail of the user via the electronic device.

### FIELD

The field relates generally to a device for performing manicure operations.

### BACKGROUND

Nail filing, buffing and color application to the nails of an individual may be time consuming and labor-intensive manual tasks that are performed by the individual or another person. Accordingly, there is a need for devices or systems that can reduce the time and/or labor associated with nail maintenance.

### SUMMARY

Illustrative embodiments provide a device configured to perform nail filing, buffing and color application and/or modification to the real or artificial fingernails of a user.

According to an embodiment, an electronic device includes a first housing portion, and a second housing portion, wherein the second housing portion comprises a recess configured to receive one of a nail filing attachment and a nail buffing attachment. In illustrative embodiments, the nail filing attachment and the nail buffing attachment are configured to be selectively removable from the second housing portion, and to engage a motor in the second housing portion. The motor moves the nail filing attachment and the nail buffing attachment in one or more directions.

According to an embodiment, a method for changing nail color comprises selecting, via a software application on a computing device, a color from a color palette comprising a plurality of color options, and transmitting from the computing device an electronic signal to an electronic device, wherein the electronic signal identifies the selected color. The electronic device generates a functional stimulus to change a color of a nail of a user to the selected color. The functional stimulus is applied to the nail of the user via the electronic device.

According to an embodiment, an electronic device includes a housing portion, wherein the housing portion comprises a recess configured to receive one of a nail filing attachment and a nail buffing attachment. In illustrative embodiments, the nail filing attachment and the nail buffing attachment are configured to be selectively removable from the housing portion, and to engage a motor in the housing portion. The nail filing attachment may include a slit between upper and lower portions of the nail filing attachment, wherein the slit is configured to receive a nail of a user.

### BRIEF DESCRIPTION OF THE DRAWINGS

FIG. 1 shows a perspective view of a manicure device in an open configuration and having a nail filing attachment inserted therein in accordance with an embodiment.

FIG. 2 shows a perspective view of the manicure device in an open configuration and having a buffing attachment inserted therein in accordance with an embodiment.

FIGS. 3A and 3B show perspective views of the manicure device in a closed configuration in accordance with an embodiment.

FIG. 4 shows a top view of the manicure device in a closed configuration in accordance with an embodiment.

FIG. 5 shows a top view of the manicure device in a closed configuration with example dimensions in accordance with an embodiment.

FIG. 6 shows a side view of the manicure device in a closed configuration with example dimensions in accordance with an embodiment.

FIG. 7A shows an operational flow for operation of a manicure device in accordance with an embodiment.

FIG. 7B shows a nail filing or nail buffing element of the manicure device in FIG. 7A in accordance with an embodiment.

FIG. 8 shows an example result of using the manicure device on a hand of a user in accordance with an embodiment.

### DETAILED DESCRIPTION

People who desire manicures and/or want to add or change the color(s) of their fingernails may not always have the time or expertise to do so. Accordingly, a need exists for an easy-to-use device to perform such tasks as filing, buffing and color changing of the fingernails of a user.

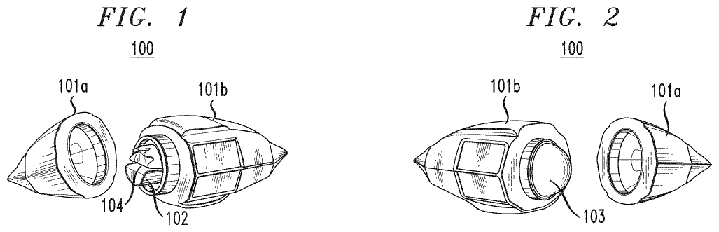

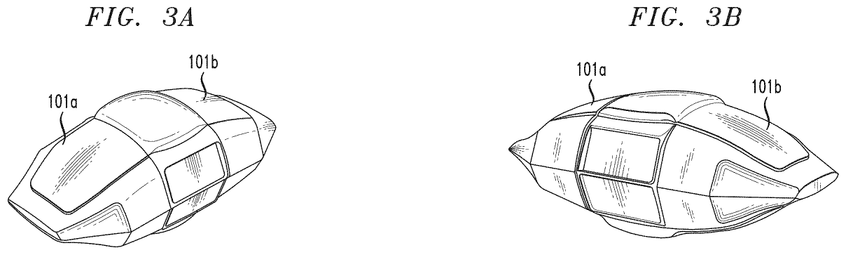

Referring to FIGS. 1 and 2, a manicure device 100 having a first housing portion 101a and a second housing portion 101b is depicted in open configurations. In FIG. 1, the manicure device 100 includes a nail filing attachment 102 inserted into and secured in the second housing portion 101b. In FIG. 2, the manicure device 100 includes a nail buffing attachment 103 inserted into and secured in the second housing portion 101b. The nail filing attachment 102 is removable from the second housing portion 101b and can be replaced by the nail buffing attachment 103. Similarly, the nail buffing attachment 103 is removable from the second housing portion 101b and can be replaced by the nail filing attachment 102. Both the nail filing attachment 102 and nail buffing attachment 103 are secured in the second housing portion 101b by a mechanical fastener (e.g., a spring or memory loaded fastener). In illustrative embodiments, the nail filing attachment 102 and nail buffing attachment 103 each include a shaft or other mechanical device for engaging with a motor in the second housing portion 101b. When the respective shafts are engaged with the motor in the second housing portion 101b, the nail filing attachment 102 and nail buffing attachment 103 can, for example, rotate in a circular motion, oscillate laterally (left and right directions), oscillate in forward and rearward directions and/or vibrate. In some embodiments, the motor may be operated at different speeds to vary the motion of the nail filing attachment 102 and nail buffing attachment 103.

The nail filing attachment 102 includes a slit 104 between upper and lower portions of the nail filing attachment 102 into which a user's real or artificial fingernail can be inserted. It is to be understood that the artificial nail is adhered to a user's finger (e.g., glued) when inserted into the slit 104. When the motor is turned on, the nail filing attachment 102, which comprises nail filing material (e.g., emery board material or other material having an appropriate grit to file nails (e.g., 80 grit to 240 grit), moves in one of the manners as described above to file the inserted real or artificial fingernail. This process can be repeated with each finger of a user.

The nail buffing attachment 103 comprises soft and/or sponge-like material commonly used for buffing a user's real or artificial fingernails. Similar to the nail filing attachment 102, it is to be understood that the artificial nail is adhered to a user's finger (e.g., glued) when the nail buffing attachment 103 is used to buff a nail. When the motor is turned on, the nail buffing attachment 103 moves in one of the manners as described above and is passed over the nail by the user to file the real or artificial fingernail. This process can be repeated with each finger of a user.

FIGS. 3A and 3B show perspective views of the manicure device 100 in a closed configuration in which the first and second housing portions 101a and 101b are secured to each other by a mechanical fastener (e.g., a spring or memory loaded fastener). Referring back to FIGS. 1 and 2, the first housing portion 101a includes a recess into which the exposed end of the nail filing attachment 102 or nail buffing attachment 103 can be inserted when the manicure device 100 is placed in the closed configuration.

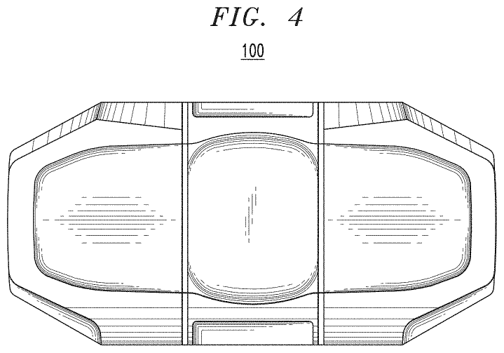

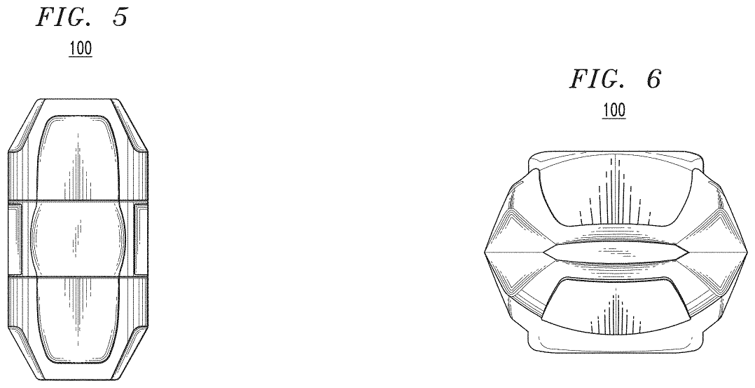

FIG. 4 shows a top view of the manicure device 100 in a closed configuration. FIG. 5 shows a top view of the manicure device 100 in the closed configuration with example dimensions. Referring to FIG. 5, the manicure device 100 has a length of about 11 inches when closed with first and second housing portions 101a and 101b secured to each other, and a width of about 5.5 inches. FIG. 6 shows a side view of the manicure device 100 in a closed configuration with example dimensions. Referring to FIG. 6, the manicure device 100 has a height of about 4 inches. It is to be understood that the embodiments are not necessarily limited to the illustrated dimensions, and the other sizes of the manicure device 100 are possible.

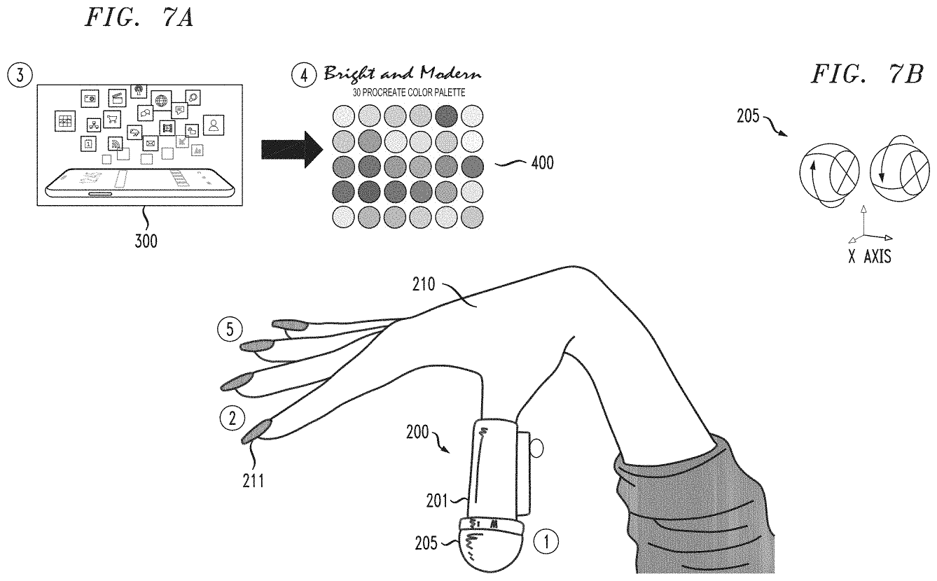

FIG. 7A shows an operational flow for operation of a manicure device 200 in accordance with an embodiment. Although the operational flow is shown with the manicure device 200, the operational flow can also apply to the manicure device 100. The manicure device includes a housing 201 and a nail filing or nail buffing element 205. Referring to FIG. 7B, the nail filing or nail buffing element 205 rotates clockwise and/or counterclockwise. Similar to the nail filing and buffing attachments 102/103, the nail filing or nail buffing element 205 includes a mechanical device for engaging with a motor such that when the motor is operating, the nail filing or nail buffing element 205 can, for example, rotate in a circular motion (as shown), oscillate laterally (left and right directions), oscillate in forward and rearward directions and/or vibrate. In some embodiments, the motor may be operated at different speeds to vary the motion of the nail filing or nail buffing element 205. The nail filing or nail buffing element 205 may be configured similarly to the nail filing and nail buffing attachments 102/103 to include, for example, a slit and nail filing material, or nail buffing material, as discussed herein above.

Referring to the operational flow, at step 1, a finger of a hand 210 (a thumb in the illustration, but can be any finger with a nail 211) in inserted into the manicure device 200, and at step 2, the nail filing or nail buffing element 205 is operated to file and buff a nail 211.

In the case of an artificial nail 211, the artificial nail 211 comprises a microchip and/or color-changing nanoparticles, color-changing pigments, color-changing dyes or other color-changing material. For example, based on temperature (e.g., heat) application, light (e.g., wavelength) application and/or stress application (e.g., pressure), the artificial nail 211 changes color. Alternatively, with a microchip, an electrical signal (e.g., low voltage) is transmitted from the manicure device 200 to a microchip in the nail 211 to cause a color change in the material of the nail 211. Referring to steps 3 and 4, after opening an application 300 on, for example a mobile device (e.g., mobile phone), tablet or other computing device, a user selects a color option from a color palette 400 provided by the application 300. Responsive to selection of a color from the color palette 400, the application 300, which is electronically linked to the manicure device 200 by, for example, Bluetooth, WiFi or other wireless means, sends a signal to the manicure device 200 identifying the selected color. Referring to step 5, responsive to receipt of the signal identifying the selected color, the manicure device 200 sends the requisite voltage to the microchip, or applies the requisite temperature, light and/or stress to the color-changing material in the nail 211 to result in the nail 211 changing to the selected color. The manicure device 200 includes the requisite circuitry, heat elements (e.g., coils), light elements (e.g., bulbs, LEDs, OLEDs, etc.), transducers, movable elements, etc. required to generate the requisite voltage, temperature, light and/or stress.

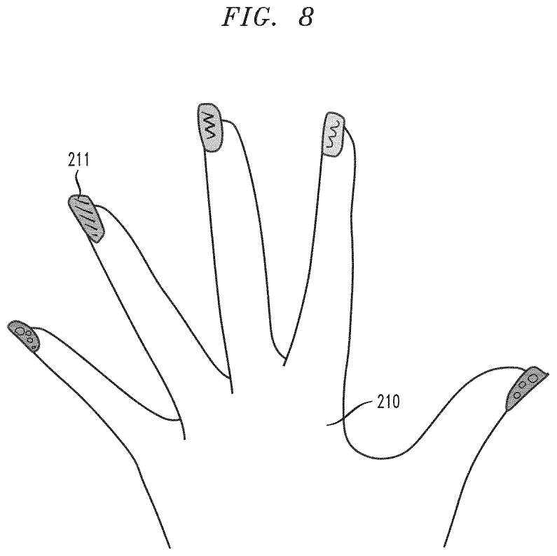

FIG. 8 shows an example result of using the manicure device on a hand 210 of a user in accordance with an embodiment. As can be seen, the nails 211 have different colors and/or patterns after using the manicure device 100/200.

Although exemplary embodiments of the present invention have been described hereinabove, it should be understood that the present invention is not limited to these embodiments, but may be modified by those skilled in the art without departing from the spirit and scope of the present invention. For example, the functionality described herein may be applied to other embodiments as future enhancements or improvements as the design becomes progressively elaborative.

What is claimed is:

1. An electronic device, comprising:
a first housing portion; and
a second housing portion;
wherein the second housing portion comprises a recess configured to receive one of a nail filing attachment and a nail buffing attachment.

2. The electronic device of claim 1, wherein the nail filing attachment and the nail buffing attachment are configured to be selectively removable from the second housing portion.

3. The electronic device of claim 1, wherein the nail filing attachment and the nail buffing attachment are configured to engage a motor in the second housing portion.

4. The electronic device of claim 3, wherein the motor moves the nail filing attachment and the nail buffing attachment in one or more directions.

5. The electronic device of claim 1, wherein the nail filing attachment comprises a slit between upper and lower portions of the nail filing attachment, wherein the slit is configured to receive a nail of a user.

6. The electronic device of claim 1, wherein the nail filing attachment comprises a nail filing material.

7. The electronic device of claim 1, wherein the nail buffing attachment comprises a nail buffing material.

8. A method for changing nail color, comprising:
selecting, via a software application on a computing device, a color from a color palette comprising a plurality of color options;
transmitting from the computing device an electronic signal to an electronic device, wherein the electronic signal identifies the selected color;
generating, by the electronic device, a functional stimulus to change a color of a nail of a user to the selected color; and
applying the functional stimulus to the nail of the user via the electronic device.

9. The method of claim 8, wherein the functional stimulus comprises a voltage corresponding to the selected color.

10. The method of claim 9, wherein the nail comprises a microchip to receive the voltage.

11. The method of claim 8, wherein the functional stimulus comprises application of heat at a temperature corresponding to the selected color.

12. The method of claim 8, wherein the functional stimulus comprises application of light at a wavelength corresponding to the selected color.

13. The method of claim 8, wherein the functional stimulus comprises application of a stress at a level corresponding to the selected color.

14. The method of claim 13, wherein the stress comprises a pressure.

15. The method of claim 8, wherein the nail comprises a color-changing material.

16. The method of claim 15, wherein the color-changing material comprises one of color-changing nanoparticles, a color-changing pigment and a color-changing dye.

17. An electronic device, comprising:
a housing portion;
wherein the housing portion comprises a recess configured to receive one of a nail filing attachment and a nail buffing attachment.

18. The electronic device of claim 17, wherein the nail filing attachment and the nail buffing attachment are configured to be selectively removable from the housing portion.

19. The electronic device of claim 17, wherein the nail filing attachment and the nail buffing attachment are configured to engage a motor in the housing portion.

20. The electronic device of claim 17, wherein the nail filing attachment comprises a slit between upper and lower portions of the nail filing attachment, wherein the slit is configured to receive a nail of a user.
